(19) United States
(12) Patent Application Publication
(10) Pub. No.: US 2025/0214265 A1
(43) Pub. Date: Jul. 3, 2025

(54) SHEARING TOOL WITH CLOSURE ASSIST

(71) Applicant: Toyota Motor Engineering & Manufacturing North America, Inc., Plano, TX (US)

(72) Inventors: Yufei Zhu, Ypsilanti, MI (US); Brian J. Pinkelman, Ann Arbor, MI (US); Michael Paul Rowe, Pinckney, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/399,075

(22) Filed: Dec. 28, 2023

(51) Int. Cl. B26B 15/00

(52) U.S. Cl. CPC B26B 15/00

(57) ABSTRACT

A shearing tool can be configured to provide closure assistance. The shearing tool can include a first portion and a second portion pivotably connected to each other. The first portion can include a handle portion and a working portion. The second portion can include a handle portion and a working portion. The shearing tool can include a contracting member operatively connected to the first portion and the second portion. When activated, the contracting member can contract such that shearing tool moves from an open configuration toward a closed configuration. As a result, assistance in closing the shearing tool can be provided by the contracting member.

### FIELD

The subject matter described herein relates in general to shearing tools and, more particularly, to the use of shearing tools.

### BACKGROUND

Scissors are shearing tools that are operated by hand. Scissors typically includes a pair of handled blades pivotably connected to each other. When the handles of the scissors are closed, the sharp edges of the blade come together and slide past each other. Scissors can be used to cut various items.

### SUMMARY

In one respect, the present disclosure is directed to a shearing tool. The shearing tool can include a first portion and a second portion pivotably connected to each other. The first portion can include a handle portion and a working portion. The second portion can include a handle portion and a working portion. The shearing tool can include a contracting member operatively connected to the first portion and the second portion. When activated, the contracting member can contract such that shearing tool moves from an open configuration toward a closed configuration. As a result, assistance in closing the shearing tool can be provided by the contracting member.

### BRIEF DESCRIPTION OF THE DRAWING

FIG. 1 is an example of shears, showing an open configuration

FIG. 2 is an example of the shears, showing a closed configuration.

FIG. 3 is an example of a system.

FIG. 4 is an example of a method.

### DETAILED DESCRIPTION

The ease of closing the scissors can be affected by various factors, such as the condition of the scissors, to the properties (e.g., thickness, material characteristics, etc.) of the material being cut, the strength of the user, and/or other factors. In some instances, it may be difficult for a user to effectively close the scissors. According to arrangements described herein, a shearing tool can be configured to assist a user in closing the shearing tool. Such arrangements can reduce or even eliminate force input by a user's hand to close the shearing tool.

The shearing tool can include a first portion and a second portion pivotably connected to each other. The shearing tool can include a contracting member operatively connected to the first portion and the second portion. When activated, the contracting member can contract such that shearing tool moves from an open configuration toward a closed configuration. As a result, assistance in closing the shearing tool can be provided by the contracting member.

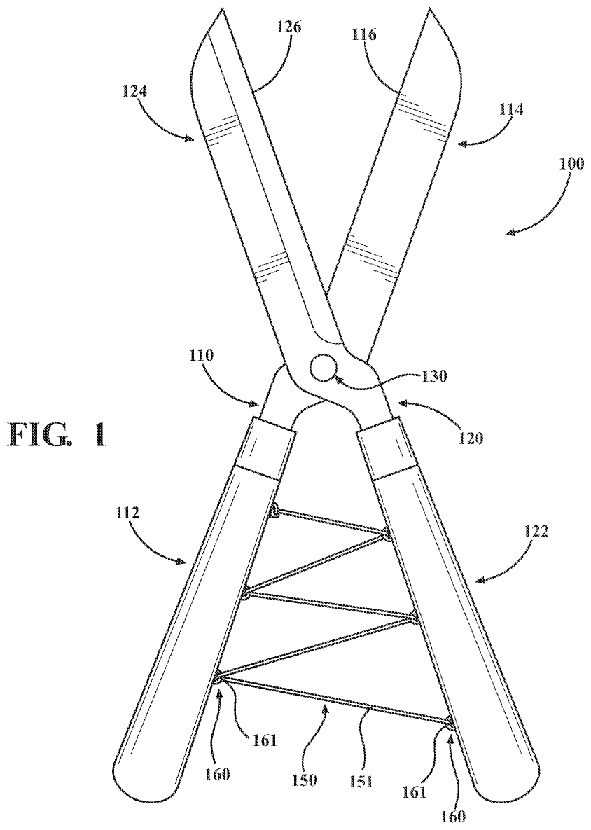

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

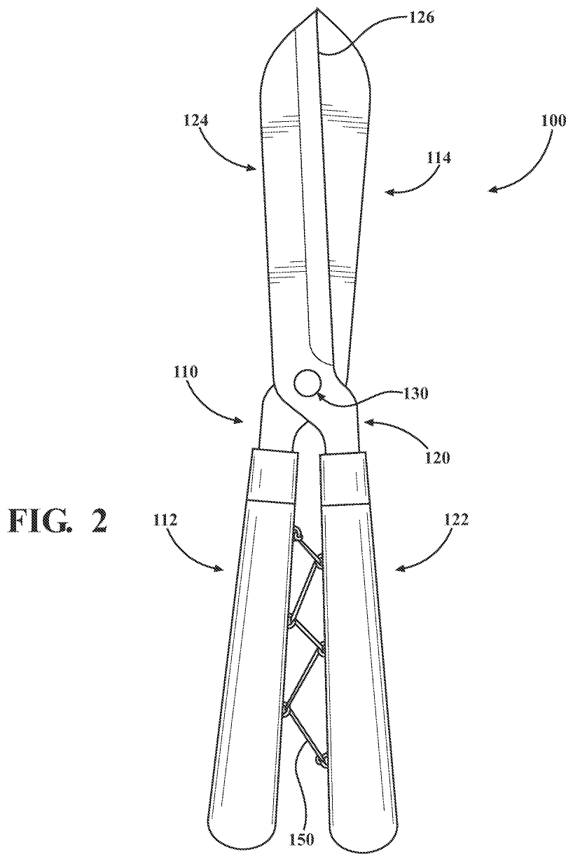

Referring to FIGS. 1 and 2, an example of a shearing tool 100 is shown. The shearing tool 100 can be configured to have one or more open configurations (e.g., FIG. 1) and a closed configuration (e.g., FIG. 2).

The shearing tool 100 can be any type of shearing tool, now known or later developed. In some arrangements, the shearing tool 100 can be shears, scissors, kitchen shears, poultry shears, cigar cutters, garden shears, grass shears, hedge trimmers, pruning shears, loppers, hair-cutting shears, thinning shears, hair clippers, nail scissors, moustache scissors, nose scissors, snips, tin snips, compound action snips, throatless shears, pipe and duct snips, trauma shears, dissection scissors, surgical scissors, iris scissors, Metzenbaum scissors, tenotomy scissors, Mayo scissors, bandage scissors, and pipe cutters, crafting scissors, applique scissors, button hole scissors, dress-maker's scissors, embroidery scissors, pinking shears, and tailor's scissors, just to name a few possibilities. It will be appreciated that, in at least some arrangements, the shearing tool can be designed for a specialize purpose. The shearing tool 100 can be configured to be operated by hand.

The shearing tool 100 can include a first portion 110 and a second portion 120. The first portion 110 and the second portion 120 can be movably connected to each other. More particularly, the first portion 110 and the second portion 120 can be pivotably connected to each other. Any suitable form of pivotable connection, now known or later developed, can be used to connect the first portion and the second portion. For instance, the first portion 110 and the second portion 120 can be pivotably connected to each other by one or more fasteners 130, such as a pin, screw (e.g., a shoulder screw, etc.).

The first portion 110 can include a handle portion 112 and a working portion 114. The working portion 114 can include a blade 116. The second portion 120 can include a handle portion 122 and a working portion 124. The working portion 124 can include a blade 126.

In some arrangements, the first portion 110 and the second portion 120 can be substantially identical to each other. In other arrangements, the first portion 110 and the second portion 120 can be different from each other in one or more respects.

The first portion 110 and the second portion 120 can be configured such that their respective blades 116, 126 slide against each other when the handle portions 112, 122 are closed.

The first portion 110 and the second portion 120 can be made of any suitable material. In some arrangements, the first portion 110 and the second portion 120 can be made of metal, plastic, wood, other suitable material, or any combination thereof. In some arrangements, the handle portions 112, 122 can be made of the same material as the working portions 114, 124. However, in other arrangements, the handle portions 112, 122 can be made of a different material than the working portions 114, 124.

In some arrangements, the handle portions 112, 122 can be configured to include one or more ergonomic features to facilitate engagement by a user. Such ergonomic features can include soft materials, grips, contours, recesses, padding, foam, soft materials, flexible materials, gel materials, other ergonomic features to facilitate such engagement, or any combination thereof.

According to arrangements herein, the shearing tool 100 can include one or more contracting members 150. The contracting member(s) 150 can be any structure, element, member, or material that, when activated, is configured to shrink in length. In one or more arrangements, the contracting member(s) 150 can be one or more shape memory material members 151, such as shape memory alloy wires.

The contracting member(s) 150 can operatively connected to and extend between the first portion 110 and the second portion 120 of the shearing tool 100. When activated, the contracting member(s) 150 can contract, drawing the handle portions 112, 122 together and closing the working portions 114, 124 of the shearing tool 100.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members 151 can be shape memory material wires. As an example, the shape memory material members 151 can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration.

The wire(s) can have any suitable characteristics. For instance, the wire(s) can be high temperature wires with austenite finish temperatures from about 80 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The pulling force of SMA wire(s) can be from about 250 MPA to about 400 MPa. The wire(s) can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members 151 to be moved from non-activated position to an activated position in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni—Ti, or nitinol). One example of a nickel-titanium shape memory alloy is FLEXINOL, which is available from Dynaolloy, Inc., Irvine, California. As further example, the SMA wires can be made of Cu—Al—Ni, Fe—Mn—Si, or Cu—Zn—Al.

The SMA wire can be configured to increase or decrease in length upon changing phase, for example, by being heated to a phase transition temperature TSMA. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austentite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the TSMA to a temperature greater than the TSMA.

Other active materials may be used in connection with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation signal.

While the shape memory material member(s) 151 can, in some implementations, be wires, it will be understood that the shape memory material member(s) 151 are not limited to being wires. Indeed, it is envisioned that suitable shape memory material member(s) 151 may be employed in a variety of other forms, such as sheets, plates, panels, strips, cables, tubes, or combinations thereof.

In some arrangements, the contracting member(s) 150 can be configured to avoid direct contact with a user. To that end, the contracting member(s) 150 can include an insulating coating or an insulating sleeve. In this way, a user's body would not directly contact the contracting member(s) 150.

The contracting member(s) 150 can extend between the first portion 110 and the second portion 120 of the shearing tool 100 in any suitable manner. For instance, the contracting member(s) 150 can extend between the handle portion 112 and the handle portion 122 of the shearing tool 100.

The contracting member(s) 150 can be operatively connected to the handle portion 122 of the shearing tool 100. Any suitable manner of operative connection can be provided, such as one or more fasteners, one or more adhesives, one or more welds, one or more brazes, one or more forms of mechanical engagement, or any combination thereof. The contracting member(s) 150 can be directly or indirectly connected to the handle portion 112 and the handle portion 122.

In FIGS. 1-2, the contracting member(s) 150 are indirectly connected to the handle portion 112 and the handle portion 122 by a plurality of fasteners 160. The plurality of fasteners 160 can be operatively connected to the handle portion 112 and the handle portion 122 in any suitable manner. The fasteners 160 can be any suitable fasteners, including hooks, loops, eyelets 161, or rings. The contracting member(s) 150 can pass through the fasteners 160. In some arrangements, the fasteners 160 can be located on inward facing sides of the handle portion 112 and the handle portion 122.

In other examples, the contracting member(s) 150 can be operatively connected directly to the handle portion 112 and the handle portion 122. For example, the contracting member(s) 150 can be operatively connected to the handle portion 112 and the handle portion 122 by one or more screws, one or more nails, one or more adhesives, and/or one or more forms of mechanical engagement, or any combination thereof. As a result, the super elastic wire(s) 16 can directly contact the handle portion 112 and the handle portion 122. In some arrangements, the contracting member(s) 150 can wrap around the handle portion 112 and the handle portion 122. In some instances, the handle portion 112 and the handle portion 122 can include grooves or channels therein to route the contracting member(s) 150.

Of course, any combination of the above manners of operative connection can be implemented.

In some arrangements, there can be a single contracting member 150. In such case, the contracting member 150 can, for example, extend substantially linearly between the handle portion 112 and the handle portion 122. In another example, the contracting member 150 can extend non-linearly between the handle portion 112 and the handle portion 122. For instance, the contracting member 150 can extend in a zigzag, serpentine, or otherwise non-linear pattern between the handle portion 112 and the handle portion 122.

In some arrangements, there can be a plurality of contracting members 150. In such case, the contracting member 150 can be distributed, arranged, and/or oriented in any suitable manner. For instance, the contracting members 150 can extend substantially parallel to each other between the handle portion 112 and the handle portion 122. In other arrangements, one or more of the contracting members 150 can extend non-parallel to the other contracting members 150. In some instances, some of the plurality of contracting members 150 may cross over each other. In some arrangements, one or more of the plurality of contracting members 150 can extend substantially linearly between the handle portion 112 and the handle portion 122. In some arrangements, one or more of the plurality of contracting members 150 can extend non-linearly between the handle portion 112 and the handle portion 122. For instance, the contracting members 150 can extend in a zigzag, serpentine, or otherwise non-linear pattern between the handle portion 112 and the handle portion 122. In some arrangements, one or more of the plurality of contracting members 150 can extend in a different manner or pattern than the other contracting members 150.

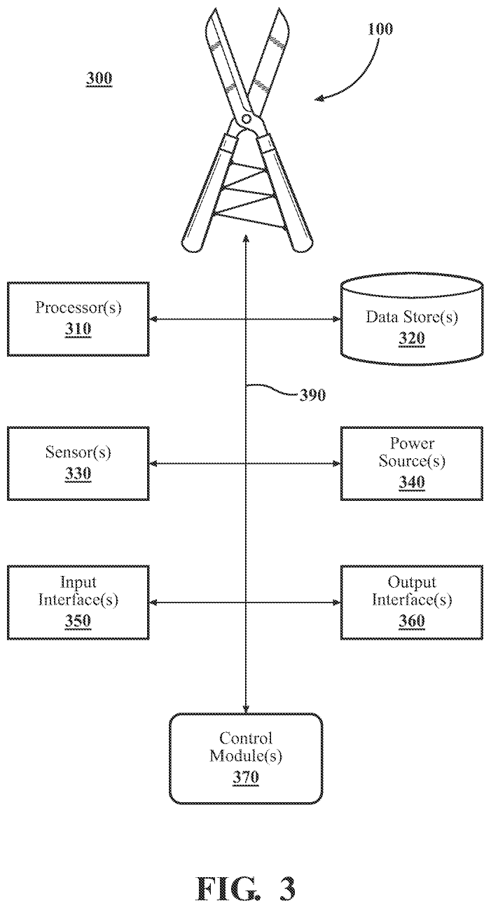

FIG. 3 shows an example of a system 300. The system 300 can include various elements. Some of the possible elements of the system 300 are shown in FIG. 3 and will now be described. It will be understood that it is not necessary for the system 300 to have all of the elements shown in FIG. 3 or described herein. The system 300 can have any combination of the various elements shown in FIG. 3. Further, the system 300 can have additional elements to those shown in FIG. 3. In some arrangements, the system 300 may not include one or more of the elements shown in FIG. 3.

The system 300 can include the shearing tool 100 as described above. The shearing tool 100, or one or more portions thereof, can be operatively connected to one or more of the elements of the system 300.

The system 300 can include one or more processors 310, one or more data stores 320, one or more sensors 330, one or more power sources 340, one or more input interfaces 350, one or more output interfaces 360, and one or more control modules 370. Each of these elements will be described in turn below. While the various elements of the system 300 may be located on or within the shearing tool 100, it will be understood that one or more of these elements can be located remote from the shearing tool 100. Further, the elements shown may be physically separated by large distances.

As noted above, the system 300 can include one or more processors 310. “Processor” means any component or group of components that are configured to execute any of the processes described herein or any form of instructions to carry out such processes or cause such processes to be performed. The processor(s) 310 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 310 can include at least one hardware circuit (e.g., an integrated circuit) configured to carry out instructions contained in program code. In arrangements in which there is a plurality of processors 310, such processors can work independently from each other, or one or more processors can work in combination with each other.

The system 300 can include one or more data stores 320 for storing one or more types of data. The data store(s) 320 can include volatile and/or non-volatile memory. Examples of suitable data stores 320 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 320 can be a component of the processor(s) 310, or the data store(s) 320 can be operatively connected to the processor(s) 310 for use thereby. The term “operatively connected,” as used throughout this description, can include direct or indirect connections, including connections without direct physical contact.

The system 300 can include one or more sensors 330. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 300 includes a plurality of sensors 330, the sensors can work independently from each other. Alternatively, two or more of the sensors can work in combination with each other. In such case, the two or more sensors can form a sensor network. The sensor(s) 330 can be operatively connected to the processor(s) 310, the data store(s) 320, and/or other elements of the system 300 (including any of the elements shown in FIG. 3).

The sensor(s) 330 can include any suitable sensor for detecting a closing of the shearing tool 100. Non-limiting examples of such sensors can include motion sensors (e.g., to detect a movement of the first portion 110 and/or the second portion 120 of the shearing tool 100), proximity sensors (e.g., to detect relative movement between portions of the shearing tool 100, such as the first portion 110 and the second portion 120), pressure sensors (e.g., to detect when a user grabs one or both of the handle portions 112, 122), force sensors (e.g., to detect a user applies a closing force to the shearing tool 100 and/or to detect when at least one of the blades 116, 126 of the shearing tool 100 exerts a force on another object), other suitable sensors, or any combination thereof.

As noted above, the system 300 can include one or more power sources 340. The power source(s) 340 can be operatively connected to supply energy to the contracting member(s) 150 of the shearing tool 100. The power source(s) 340 can be any power source capable of and/or configured to energize the contracting member(s) 150 of the shearing tool 100. For example, the power source(s) 440 can include one or more batteries, one or more fuel cells, one or more generators, one or more alternators, one or more solar cells, one or more heaters, one or more energy sources, and combinations thereof.

The system 300 can include one or more input interfaces 350. An “input interface” includes any device, component, system, element or arrangement or groups thereof that enable information/data to be entered into a machine. The input interface(s) 350 can receive an input from a user of the shearing tool 100. Any suitable input interface 350 can be used, including, for example, a keypad, display, touch screen, multi-touch screen, button, switch, joystick, mouse, trackball, microphone and/or combinations thereof. In some arrangements, the input interface(s) 350 can be located on the shearing tool 100. In other arrangements, the input interface(s) 350 can be located remotely from the shearing tool 100.

The system 300 can include one or more output interfaces 360. An “output interface” includes any device, component, system, element or arrangement or groups thereof that enable information/data to be presented to a user of the shearing tool 100. The output interface(s) 360 can present information/data to a chair occupant. The output interface(s) 360 can include a display, an earphone, and/or speaker. Some components of the system 300 may serve as both a component of the input interface(s) 350 and a component of the output interface(s) 360.

The system 300 can include one or more modules, at least some of which will be described herein. The modules can be implemented as computer readable program code that, when executed by a processor, implement one or more of the various processes described herein. One or more of the modules can be a component of the processor(s) 310, or one or more of the modules can be executed on and/or distributed among other processing systems to which the processor(s) 310 is operatively connected. The modules can include instructions (e.g., program logic) executable by one or more processor(s) 310. Alternatively or in addition, one or more data stores 320 may contain such instructions.

In one or more arrangements, the modules described herein can include artificial or computational intelligence elements, e.g., neural network, fuzzy logic, or other machine learning algorithms. Further, in one or more arrangements, the modules can be distributed among a plurality of modules. In one or more arrangements, two or more of the modules described herein can be combined into a single module.

The system 300 can include one or more control modules 370. The control module(s) 370 can be configured to receive signals, data, information, and/or other inputs from one or more elements of the system 300. The control module(s) 370 can be configured to analyze these signals, data, information, and/or other inputs. The control module(s) 370 can be configured to select one or more of the contracting member(s) 150 to be activated or deactivated to achieve a desired effect. In some arrangements, the control module(s) 370 can be configured to select a predefined actuation profile from the data store(s) 320 to effectuate a desired actuation. Alternatively or additionally, the control module(s) 370 can be configured to detect user inputs (e.g., commands) provided on the input interface(s) 350. The control module(s) 370 can be configured to send control signals or commands over a communication network 390 to one or more elements of the system 300, including the shearing tool 100, the contracting member(s) 150, and/or any portion thereof.

The control module(s) 370 can be configured to cause the closure assist of the shearing tool 100 to be activated or deactivated by activating or deactivating the respective contracting member(s) 150 associated with the shearing tool 100. As used herein, “cause” or “causing” means to make, force, compel, direct, command, instruct, and/or enable an event or action to occur or at least be in a state where such event or action may occur, either in a direct or indirect manner. The control module(s) 370 can selectively provide an activation input to the shearing tool 100 or, more particularly, to the contracting member(s) 150 associated with the shearing tool 100. The control module(s) 370 can selectively permit or prevent the flow of electrical energy from the power source(s) 340.

The various elements of the system 300 can be communicatively linked to one another or one or more other elements through one or more communication networks 390. As used herein, the term “communicatively linked” can include direct or indirect connections through a communication channel, bus, pathway or another component or system. A “communication network” means one or more components designed to transmit and/or receive information from one source to another. The data store(s) 320 and/or one or more other elements of the system 300 can include and/or execute suitable communication software, which enables the various elements to communicate with each other through the communication network and perform the functions disclosed herein.

The one or more communication networks 390 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network 390 can include any combination of the above networks and/or other types of networks.

Now that the various potential systems, devices, elements and/or components have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

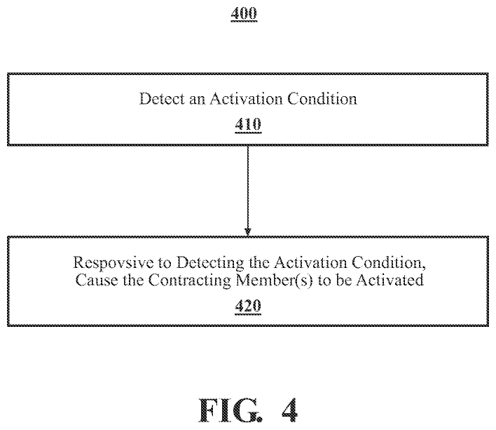

Turning to FIG. 4, an example of a method 400 is shown. At block 410, an activation condition can be detected. Such detection can be performed by the processor(s) 310, the sensor(s) 330, and/or the control module(s) 370. In some arrangements, the activation condition can be the closing of the shearing tool 100. In such cases, the detection of the activation condition can be based on sensor data acquired by the sensor(s) 330. In one or more arrangements, the activation condition can be a user command. In such cases, the activation condition can be based on a user input provided on the input interface(s) 350. If an activation condition is not detected, then no action may be taken. If an activation condition is detected, the method can continue to block 420.

At block 420, responsive to detecting the activation condition, the contracting member(s) 150 can be caused to be activated. The activation of the contracting member(s) 150 can cause the shearing tool 100 to close or to assist the closing of the shearing tool 100 to close. Causing the activation of the contracting member(s) 150 can be performed by the processor(s) 310 and/or the control module(s) 370. For instance, the processor(s) 310 and/or the control module(s) 370 can cause or allow the flow of energy from the power sources(s) 340 to the contracting member(s) 150. In a particular example, the processor(s) 310 and/or the control module(s) 370 can cause or allow the flow of electrical energy from the power sources(s) 340 to the contracting member(s) 150 or the shape memory material member(s) 151 of the shearing tool 100. As a result, the contracting member(s) 150 can contract, thereby causing the handle portions 112, 122 of the first portion 110 and the second portion 120 to be drawn toward each other. In some arrangements, the contraction of the contracting member(s) 150 can be sufficient to cause the shearing tool 100 to close. In some arrangements, the contraction of the contracting member(s) 150 can supplement the closing force applied to the shearing tool 100 by a user's hand(s).

In some arrangements, the causing in block 420 can occur in response to a user input. For example, the processor(s) 310 and/or the control module(s) 370 can be configured to detect user inputs (e.g., commands) provided on the input interface(s) 350. In response, the processor(s) 310 and/or the control module(s) 370 can be configured to cause or allow the flow of energy from the power sources(s) 340 to the contracting member(s) 150. In a particular example, the processor(s) 310 and/or the control module(s) 370 can cause or allow the flow of electrical energy from the power sources(s) 340 to the contracting member(s) 150 or the shape memory material member(s) 151 of the shearing tool 100.

After the shearing tool is closed or at any other suitable time (e.g., a user command or a when the first portion 110 and/or the second portion 120 is no longer moving), the activation input to the contracting member(s) 150 can be discontinued. The contracting member(s) 150 can cool. As a result, the contracting member(s) 150 can become relaxed and the overall length of the contracting member(s) 150 can increase.

The method 400 can end. Alternatively, the method 400 can return to block 410 or to some other block. The method 400 can be repeated at any suitable point, such as at a suitable time or upon the occurrence of any suitable event or condition.

It will be appreciated that arrangements described herein can provide numerous benefits, including one or more of the benefits mentioned herein. For example, arrangements described herein can reduce or even eliminate the force exerted by a user's hand(s) to close a shearing tool. Arrangements described herein can enhance user interaction with a shearing tool. Arrangements described here can improve the performance of a shearing tool.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A shearing tool comprising:
a first portion including a handle portion and a working portion;
a second portion including a handle portion and a working portion, the first portion and the second portion being pivotably connected to each other; and
a contracting member operatively connected to the first portion and the second portion, when activated, the contracting member contracts such that shearing tool moves from an open configuration toward a closed configuration, whereby closure assistance is provided by the contracting member.

2. The shearing tool of claim 1, wherein the contracting member is a shape memory material member.

3. The shearing tool of claim 2, wherein the shape memory material member is a shape memory alloy wire.

4. The shearing tool of claim 1, wherein the contracting member is operatively connected to the handle portion of the first portion and the handle portion of the second portion.

5. The shearing tool of claim 4, wherein the contracting member extends in a non-linear pattern between the handle portion of the first portion and the handle portion of the second portion.

6. The shearing tool of claim 1, further including:
a power source operatively connected to supply energy to the contracting member; and
one or more processors operatively connected to the power source, wherein the one or more processors are configured to selectively control a supply of energy to the contracting member.

7. The shearing tool of claim 6, further including a sensor, wherein the sensor is operatively connected to the one or more processors, and wherein the sensor is configured to acquire sensor data about the shearing tool.

8. The shearing tool of claim 7, wherein the one or more processors are configured to:
detect an activation condition; and
responsive to detecting the activation condition, cause the contracting member to be activated.

9. The shearing tool of claim 6, further including an input interface configured to receive a user input, wherein the input interface is operatively connected to the one or more processors, and wherein the one or more processors are configured to:
responsive to receiving a user input on the input interface, cause the contracting member to be activated.

10. The shearing tool of claim 1, wherein at least a portion of the contracting member is insulated.
